(19) United States
(12) Patent Application Publication
(10) Pub. No.: US 2020/0231903 A1
(43) Pub. Date: Jul. 23, 2020

(54) PHASE SELECTIVE DEFOAMER

(71) Applicant: BASF SE, Ludwigshafen (DE)

(72) Inventor: Juergen Tropsch, Ludwigshafen (DE)

(21) Appl. No.: 16/647,583

(22) PCT Filed: Oct. 4, 2018
(86) PCT No.: PCT/EP2018/076985

§ 371 Date: Mar. 16, 2020

(30) Foreign Application Priority Data
Oct. 5, 2017 (EP) 17194932.4

(51) Int. Cl. C11D 3/00; C11D 1/00; C11D 3/20; C11D 17/00; C11D 11/00

(52) U.S. Cl. CPC C11D 3/0026; C11D 1/002; C11D 11/0017; C11D 17/0008; C11D 3/2093

(57) ABSTRACT

The present disclosure is related to a foam forming aqueous composition including at least 100 ppm of a detergent being a compound of formula (I)

R¹OOC—Z—COOR² (I),

in which R¹ and R² are independently from each other selected from C₁-C₂₀ branched alkyl, C₅-C₁₀ cycloalkyl or C₅-C₁₄ aryl or heteroaryl and can be different or identical. The linker Z is selected from divalent aliphatic or aromatic groups such as —(CH₂)ₙ— with n=1-20,

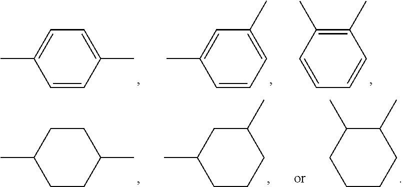

The ratio between the detergent and the defoamer is in the range of 19:1 to 35:1. Also disclosed is a washing process in which the foam forming aqueous composition is applied, and a laundry detergent.

### FIELD OF THE INVENTION

The present invention is related to a foam forming aqueous composition comprising at least 2.0 g/L of a detergent and at least one defoamer being a compound of formula (I), a washing process wherein said foam forming aqueous composition is applied and a laundry detergent.

### BACKGROUND OF THE INVENTION

The application of defoamers is well known in the art in the field of detergent compositions. Detergents contain ionic or non-ionic surfactants which act as foaming agents due to their strong film forming capacity. Such surfactant foams have a large internal surface and, therefore, a strong adsorption capacity which is of advantage in cleaning and washing processes. However, to avoid too much foam formation and to facilitate the removal of the foam after the washing process, detergent compositions usually contain defoamers.

A defoamer or anti-foaming agent is an additive which reduces or hinders the formation of a foam. Defoamers are chemical formulations of high surface activity which are capable of suppressing undesired foam formation as well as destroying existing foam. In the field of detergents, silicone and alcohol alkoxylate defoamers are commonly used. However, silicone defoamers are already active in the main washing cycle and destroy the formed foam very quickly. Alcohol alkoxylate defoamers, on the other hand, do not reduce the foam volume in the main cycle, but the foam is not sufficiently destroyed during the rinsing cycle.

Therefore, there is a need in the art for a defoamer which breaks the foam at the desired time within the washing process. A foam reduction which already occurs during the main cycle is regarded as a negative property of a detergent and is, therefore, undesired which applies especially for a laundry detergent for manual wash. Thus, it is desired that the effect of the defoamer only occurs during the following rinsing cycles and accelerates the defoaming process.

Accordingly, it is an object of the present invention to provide a defoamer which does not affect the foam volume during the main washing cycle, but breaks the foam effectively during the rinsing cycle.

### SUMMARY OF THE INVENTION

The foregoing and other objects are solved by the subject-matter of the present invention.

According to a first aspect of the present invention, a foam forming aqueous composition comprising at least 2.0 g/L of a detergent and at least one defoamer being compound of formula (I)

R¹OOC—Z—COOR² (I),

wherein R¹ and R² are independently from each other selected from C₁-C₂₀ branched alkyl, C₅-C₁₀ cycloalkyl or C₅-C₁₄ aryl or heteroaryl and can be different or identical, the latter being preferred,
and the linker Z is selected from divalent aliphatic or aromatic groups such as —(CH₂)ₙ— with n=1-20,

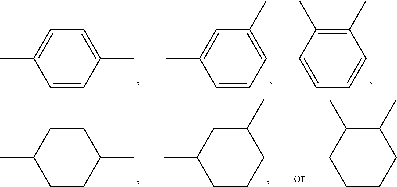

and wherein the ratio between the detergent and the defoamer is in the range of 19:1 to 35:1 is provided.

The inventors surprisingly found out that agitation of a composition comprising at least 2.0 g/L of a detergent and at least one defoamer being a compound of formula (I) leads to the formation of a stable foam despite the fact that the defoamer is present in the composition.

According to a further aspect of the present invention, the defoamer has a surface tension in the range of 23 to 35 mN/m.

According to a second aspect of the present invention, a foam forming aqueous composition comprising at least 2.0 g/L of a detergent and at least one defoamer having a surface tension in the range of 23 to 35 mN/m is provided.

It was surprisingly found that a defoamer having a surface tension in the range of 25 to 32 mN/m allows the formation of a stable foam when the detergent concentration is 2.0 g/L or higher and breaks the foam when the detergent concentration is decreased to 0.7 g/L or less.

According to another aspect of the present invention, the defoamer is selected from phthalic esters, adipic acid esters, cyclohexane dicarboxylic acid esters or mixtures thereof.

It is especially preferred that the defoamer is selected from diisononyl phthalate, di-2-propyl-heptyl phthalate, cyclohexane dicarboxylic acid diisononylester, adipic acid di-2-ethylhexylester, adipic acid diisononylester or mixtures thereof.

According to another aspect of the present invention, the detergent is selected from linear alkylbenzenesulfonates, alkylethersulfates, alkylsulfates or mixtures thereof.

According to a further aspect of the present invention, a foam obtained from the foam forming composition as defined above is provided.

According to still another aspect of the present invention, the present invention is directed to a washing process, comprising the steps of providing a foam forming aqueous composition comprising at least 2.0 g/L of a detergent and a defoamer as defined above, a main washing cycle wherein the foam forming composition is agitated so that foam formation occurs, and a subsequent rinsing cycle wherein the composition is diluted so that the detergent concentration is reduced to 0.7 g/L or less.

According to a further aspect of the present invention, the volume of the foam obtained in the main washing cycle is not reduced by more than 10%, compared to an aqueous composition of identical detergent concentration not comprising any defoamer, during the main washing cycle and reduced by at least 80%, compared to the initial foam volume obtained in the main washing cycle, during the subsequent rinsing cycle.

According to a further aspect of the present invention, a laundry detergent comprising 95 to 99.5 wt.-% of a detergent and 0.5 to 5.0 wt.-% of at least one defoamer of formula (I) as defined above and/or having a surface tension in the range of 23 to 35 mN/m is provided.

It is preferred that the defoamer of the laundry detergent is selected from phthalic esters, adipic acid esters, cyclohexane dicarboxylic acid esters or mixtures thereof.

In particular, it is preferred that the defoamer of the laundry detergent is selected from diisononyl phthalate, di-2-propyl-heptyl phthalate, cyclohexane dicarboxylic acid diisononylester, adipic acid di-2-ethylhexylester, adipic acid diisononylester or mixtures thereof.

It is especially preferred that said laundry detergent is a laundry detergent for handwash.

In the following, the present invention is described in more detail.

### DETAILED DESCRIPTION OF THE INVENTION

A foam forming aqueous composition comprising at least 2.0 g/L of a detergent and at least one defoamer being compound of formula (I)

R¹OOC—Z—COOR² (I),

wherein R¹ and R² are independently from each other selected from C₁-C₂₀ branched alkyl, C₅-C₁₀ cycloalkyl or C₅-C₁₄ aryl or heteroaryl and can be different or identical, the latter being preferred,
and the linker Z is selected from divalent aliphatic or aromatic groups such as —(CH₂)ₙ— with n=1-20,

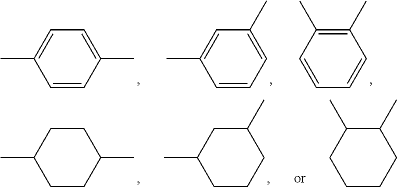

and wherein the ratio between the detergent and the defoamer is in the range of 19:1 to 35:1 is provided.

It was surprisingly found out by the inventors that agitation of a composition comprising at least 2.0 g/L of a detergent and at least one defoamer being a compound of formula (I) leads to the formation of a stable foam despite the fact that the defoamer is present in the composition. When the composition is subsequently diluted so that the detergent concentration decreases to 0.7 g/L or less, the foam volume is reduced significantly. Thus, it was found that a defoamer being a compound of formula (I) is not active during the main washing cycle and allows the formation of a stable foam. When the washing liquor is diluted in the rinsing cycle, however, said defoamer is able to break the foam formed during the main washing cycle. Therefore, the foam forming composition according to the present invention is applicable if the formation of a stable foam is desired in the main washing cycle which is easily removable in the rinsing cycle.

As used herein, the term “detergent” is related to a composition comprising a surfactant or a surfactant composition with cleaning properties in aqueous solution. Next to the surfactant or surfactant composition, typical components of a detergent are water softeners, bleach, enzymes, corrosion inhibitors, dye transfer inhibitors, antiredepotion agents, optical brighteners, fabric softeners, colorants and perfumes.

As used herein, the term “surfactant” is related to compounds comprising a polar hydrophilic and a non-polar hydrophobic part and, therefore, have amphiphilic properties. Depending on the electrical charge of the surfactants, they are classified into anionic, cationic and non-ionic or zwitter-ionic surfactants.

As used herein, the term “main washing cycle” is related to a washing cycle wherein the detergent concentration in the washing liquor is at least 2.0 g/L.

As used herein, the term “rinsing cycle” is related to a washing cycle wherein the detergent concentration in the washing liquor is 0.7 g/L or less.

As used herein, the term “washing liquor” is related to the utility solution comprising the detergent which is in contact with textiles or fabrics and the soiling contained therein. A washing liquor is usually generated in the beginning of a washing process when the detergent is diluted with water in the washing machine or a suitable container.

Thus, according to a preferred embodiment of the present invention, the inventive foam forming aqueous composition is a washing liquor.

As used herein, the term “foam” is related to a colloidal system comprising gas-filled spherical or polyhedral cells limited by fluid, semi-liquid or highly viscous cell walls. The formation of a foam is favored by surface active compounds which are capable of film formation. Such surface active compounds are also referred to as foamers. Typical foamers in an aqueous solution are surfactants.

As used herein, the term “defoamer” is related to an additive having a low surface tension which hinders the formation of foam and/or breaks existing foam by destroying the cell walls of the foam cells.

It was found that compounds of formula (I) are defoamers showing the desired activity profile, i.e. low influence on the foam volume in the main washing cycle and effective foam reduction in the rinsing cycle.

According to a preferred embodiment of the present invention, the defoamer is selected from phthalic esters, adipic acid esters, cyclohexane dicarboxylic acid esters or mixtures thereof.

It is particularly preferred that the defoamer is selected from C₁-C₂₀ branched alkyl, C₅-C₁₀ cycloalkyl and/or C₅-C₁₄ aryl or heteroaryl diesters of phthalic acid, adipic acid or cyclohexane dicarboxylic acid, wherein said diesters are mixed diesters or non-mixed diesters, the latter being preferred.

Still more preferably, the defoamer is selected from non-mixed C₆-C₁₅ branched alkyl diesters of phthalic acid, adipic acid or cyclohexane dicarboxylic acid.

It is especially preferred that the defoamer is selected from diisononyl phthalate, di-2-propyl-heptyl phthalate, cyclohexane dicarboxylic acid diisononylester, adipic acid di-2-ethylhexylester, adipic acid diisononylester or mixtures thereof.

According to another embodiment of the present invention, the defoamers according to the present invention are characterized by a specific surface tension. As outlined above, defoamers are featured by a rather low surface tension and are, therefore, able to destroy the walls of the foam cells. Since the inventive foam forming composition is capable of forming a stable foam at a detergent concentration of 2.0 g/L or higher, it is required that the defoamer has a moderate surface tension which is not sufficient to break the foam at detergent concentrations of 2.0 g/L or higher.

Thus, it is preferred that the defoamer according to the present invention has a surface tension in the range of 23 to 35 mN/m, more preferably in the range of 24 to 34 mN/m, still more preferably in the range of 25 to 32 mN/m.

Additionally to the previous paragraph, it is preferred that the defoamer is not an alcohol alkoxylate.

It is preferred that the inventive foam forming aqueous composition contains at least 0.05 g/L of the defoamer, more preferably at least 0.10 g/L, still more preferably at least 0.12 g/L, like at least 0.15 g/L.

According to a preferred embodiment of the present invention, the detergent is selected from linear alkylbenzenesulfonates, alkylethersulfates, alkylsulfates or mixtures thereof.

Thus, the detergent is preferably selected from linear sodium C₈-C₃₀-alkylbenzenesulfonates, sodium C₈-C₃₀-alkylpoly(oxyethylene)sulfates, sodium C₈-C₃₀-alkylsulfates or mixtures thereof, more preferably from linear sodium C₁₀-C₁₅-alkylbenzenesulfonates, sodium C₁₀-C₁₅-alkylpoly(oxyethylene)sulfates, sodium C₁₀-C₁₅-alkylsulfates or mixtures thereof.

It is especially preferred that the detergent is selected from sodium C₁₀-C₁₃-benzenesulfonate, sodium C₁₂-C₁₄-poly(oxyethylene)sulfate, sodium C₁₂-C₁₄-sulfate or mixtures thereof.

According to a preferred embodiment of the present invention, the inventive foam forming aqueous composition contains at least 2.0 g/L, more preferably at least 3.0 g/L, still more preferably at least 5.0 g/L of the detergent.

Further, the defoamer and the detergent are present in the inventive composition in a specific ratio.

In particular, the ratio between the detergent and the defoamer is in the range of 19:1 to 35:1, preferably in the range of 25:1 to 35:1, more preferably in the range of 30:1 to 35:1.

According to a further embodiment of the present invention, a washing process is provided, said washing process comprising the steps of providing a foam forming aqueous composition comprising at least 2.0 g/L of a detergent and a defoamer being a compound of formula (I) as defined above, a main washing cycle wherein the foam forming composition is agitated so that foam formation occurs, and a subsequent rinsing cycle wherein the composition is diluted so that the detergent concentration is reduced to 0.7 g/L or less.

The definitions of the defoamer and the detergent used in the inventive washing process correspond to the definitions provided above.

Preferably, the defoamer concentration in the main washing cycle is least 0.05 g/L of the defoamer, more preferably at least 0.10 g/L, still more preferably at least 0.12 g/L, like at least 0.15 g/L.

Further, it is preferred that the defoamer concentration in the rinsing cycle is 0.005 g/L or less of the defoamer, more preferably 0.01 g/L or less, still more preferably 0.012 g/L or less, like 0.015 g/L or less.

According to a preferred embodiment of the present invention, the detergent concentration in the main washing cycle is least 2.0 g/L, more preferably at least 3.0 g/L, still more preferably at least 5.0 g/L of the detergent.

Additionally, it is preferred that the detergent concentration in the rinsing cycle is 0.7 g/L or less. More preferably, the detergent concentration in the rinsing cycle 0.2 g/L or less, still more preferably 0.3 g/L or less, like 0.5 g/L or less.

Accordingly, it is particularly preferred that the foam forming aqueous composition is diluted by a factor of at least ten in the rinsing cycle.

In the main washing cycle, the foam forming composition comprising the defoamer and at least 2.0 g/L of the detergent is agitated whereupon a stable foam is formed. Accordingly, the inventive defoamer is not active at detergent concentrations of 2.0 g/L or higher. The defoamer can be activated by diluting the composition with water so that the resulting detergent concentration is 0.7 g/L or less. At low detergent concentrations, it was observed that the foam produced in the foregoing washing cycle is reduced significantly.

In particular, the volume of the foam obtained in the main washing cycle is not reduced by more than 10%, compared to an aqueous composition of identical detergent concentration not comprising any defoamer, during the main washing cycle and reduced by at least 80%, compared to the initial foam volume obtained in the main washing cycle, during the subsequent rinsing cycle.

More preferably, the volume of the foam obtained in the main washing cycle is not reduced by more than 8%, compared to an aqueous composition of identical detergent concentration not comprising any defoamer, during the main washing cycle and reduced by at least 85%, compared to the initial foam volume obtained in the main washing cycle, during the subsequent rinsing cycle.

It is especially preferred that the volume of the foam obtained in the main washing cycle is not reduced by more than 7%, compared to an aqueous composition of identical detergent concentration not comprising any defoamer, during the main washing cycle and reduced by at least 90%, compared to the initial foam volume obtained in the main washing cycle, during the subsequent rinsing cycle.

Further, a laundry detergent is provided comprising 95 to 99.5 wt.-% of a detergent and 0.5 to 5.0 wt.-% of a defoamer being a compound of formula (I) as defined above.

As used herein, the term “laundry detergent” is related to a dry or liquid formulation as defined below comprising at least one detergent.

The inventive laundry detergent preferably comprises the detergent and the defoamer in a ratio of 19:1 to 35:1, more preferably in the range of 25:1 to 35:1, still more preferably in the range of 30:1 to 35:1.

According to a preferred embodiment, the defoamer of the laundry detergent is selected from phthalic esters, adipic acid esters, cyclohexane dicarboxylic acid esters or mixtures thereof.

More preferably, the defoamer of the laundry detergent is selected from C₁-C₂₀ branched alkyl, C₅-C₁₀ cycloalkyl and/or C₅-C₁₄ aryl or heteroaryl diesters of phthalic acid, adipic acid or cyclohexane dicarboxylic acid, wherein said diesters are mixed diesters or non-mixed diesters, the latter being preferred.

It is particularly preferred that the defoamer of the laundry detergent is selected from non-mixed C₆-C₁₅ branched alkyl diesters of phthalic acid, adipic acid or cyclohexane dicarboxylic acid.

It is especially preferred that the defoamer is selected from diisononyl phthalate, di-2-propyl-heptyl phthalate, cyclohexane dicarboxylic acid diisononylester, adipic acid di-2-ethylhexylester, adipic acid diisononylester or mixtures thereof.

Additionally or alternatively to the previous paragraphs, the defoamer of the laundry detergent is featured by a surface tension in the range of 23 to 35 mN/m, more preferably in the range of 24 to 34 mN/m, still more preferably in the range of 25 to 32 mN/m.

The laundry detergent comprises 95 to 99.5 wt.-% of the detergent and 0.5 to 5.0 wt.-% of the defoamer, more preferably 96 to 98 wt.-% of the detergent and 2.0 to 4.0 wt.-% of the defoamer, still more preferably 96.5 to 97 wt.-% of the detergent and 3.0 to 3.5 wt.-% of the defoamer.

Next to the detergent and the defoamer, the laundry detergent according to the present invention may comprise further additives which are usually applied for laundry detergents. Non-limiting examples for such additives are water softeners, bleach, enzymes, corrosion inhibitors, dye transfer inhibitors, antiredepotion agents, optical brighteners, fabric softeners, colorants and perfumes.

The inventive laundry detergent is preferably applicable for the preparation of the foam forming aqueous composition as defined above. In particular, the foam forming aqueous composition in accordance with the present invention is obtained by diluting the inventive laundry detergent with water so that the detergent concentration is 2.0 g/L or higher.

Accordingly, the foam forming composition in accordance with the present invention may also contain the above mentioned additives.

The inventive laundry detergent is preferably formulated in a dry or liquid formulation.

The term “dry formulation” as used herein, refers to formulations that are in a form of a powder, granules or tablets. It is appreciated that the “dry formulation” has a moisture content of ≤20 wt.-%, more preferably ≤15 wt.-%, even more preferably ≤10 wt.-% and most preferably ≤7.5 wt.-%, based on the total weight of the formulation. If not otherwise indicated, the moisture content is determined according to the Karl Fischer method as outlined in DIN EN 13267:2001.

If the dry formulation is provided in form of a powder, the formulation is preferably a high concentrated powder formulation having a bulk density of above 400 g/L, more preferably above 500 g/L, still more preferably above 600 g/L.

The term “liquid formulation” as used herein, refers to formulations that are in a form of a “pourable liquid”; “gel” or “paste”.

A “pourable liquid” refers to a liquid formulation having a viscosity of <3000 mPa·s at 25° C. at a shear rate of 20 sec⁻¹. For example, the pourable liquid has a viscosity in the range of from 200 to 2000 mPa·s, preferably from 200 to 1500 mPa·s and most preferably from 200 to 1000 mPa·s, at 25° C. at a shear rate of 20 sec⁻¹.

A “gel” refers to a transparent or translucent liquid formulation having a viscosity of >2000 mPa·s at 25° C. at a shear rate of 20 sec⁻¹. For example, the gel has a viscosity in the range of from 2000 to about 10000 mPa·s, preferably from 5000 to 10 000 mPa·s, at a shear rate of 0.1 sec-¹.

A “paste” refers to an opaque liquid formulation having a viscosity of greater than about 2000 mPa·s at 25° C. and a shear rate of 20 sec⁻¹. For example, the paste has a viscosity in the range of from 3000 to 10 000 mPa·s, preferably from 5000 to 10 000 mPa·s, at 25° C. at a shear rate of 0.1 sec⁻¹.

In the field of laundry detergents for handwash, the reduction of the foam in the main washing cycle occurring when the defoamers according to the prior art are applied is particularly undesirable. Therefore, the inventive foam forming composition is particularly advantageous for the use in laundry detergents for handwash.

It is especially preferred that the laundry detergent according to the present invention is a laundry detergent for handwash.

The scope and interest of the invention will be better understood based on the following examples which are intended to illustrate certain embodiments of the invention and are non-limitative.

### EXAMPLES

The following tests were conducted to determine the stability of the foam in the main washing cycle and the rinsing cycle depending on the defoamer.

Detergent Composition

The detergent composition used in the following examples comprises the following compounds:

20 wt.-% Sodium C₁₀-C₁₃-alkylbenzenesulfonate (NaLAS)

40 wt.-% Sodium carbonate

40 wt.-% Sodium sulfate

Apparatus

For the simulation of the washing process, an apparatus comprising a 2000 mL PE-beaker, a stirring unit (IKA RW 20), a rpm counter (IKA-Tron DZM 1) and an anchor stirrer made of stainless steel having a blade thickness of 0.1 cm was used.

Defoamers

The defoaming properties of the following compounds was tested:

| | | Surface tension |
|---|---|---|
| Defoamer | | [mN/m] |
| Silicon defoamer | | 21.0 |
| Alcohol alkoxylat | C₁₂C₁₄-fatty alcohol + | n.d. |
| | 3 EO + 6 PO | |
| A | Diisononyl phthalate | 31.0 |
| B | Di-2-propyl-heptyl phthalate | 30.0 |
| C | Cyclohexane dicarboxylic acid | 30.0 |
| | diisononylester | |
| D | Adipic acid di-2-ethylhexylester | 30.0 |
| E | Adipic acid diisononylester | 30.0 |

The surface tension was determined according to EN 14370 for the substances as they are.

Typically, after the main washing cycle and wringing out the laundry, the remaining washing liquor in the laundry is diluted with fresh water by a factor or 10. This is simulated by diluting the used compounds ten times.

Simulation of the Main Washing Cycle

The beaker is filled with 400 mL of a washing liquor (detergent concentration 5.0 g/L, water hardness 10° dH, Ca²⁺ only) and 0.06 g of the defoamer is added which corresponds to a concentration of 0.15 g/L. The anchor stirrer is immersed into the mixture so that the upper end of the stirring blade protrudes from the mixture about 2.3 cm. The mixture is stirred at 400 rpm for 1 min and the foam volume is measured after another minute.

Simulation of the Rinsing Cycle

The beaker is filled with 400 mL of a washing liquor (detergent concentration 0.5 g/L, water hardness 10° dH, Ca²⁺ only) and 0.006 g of the defoamer is added which corresponds to a concentration of 0.015 g/L. The anchor stirrer is immersed into the mixture so that the upper end of the stirring blade protrudes from the mixture about 2.3 cm. The mixture is stirred at 400 rpm for 1 min and the foam volume is measured after another minute.

Results

| | Foam volume | Foam volume |
|---|---|---|
| | (main cycle¹⁾) | (rinsing cycle²⁾) |
| Defoamer | [mL] | [mL] |
| none | 155 | 90 |
| Silicon defoamer | 30 | 0 |
| Alcohol alkoxylate | 170 | 70 |
| A | 160 | 10 |
| B | 145 | 5 |
| C | 170 | 5 |
| D | 145 | 5 |
| E | 185 | 5 |

¹⁾detergent concentration = 5.0 g/L, defoamer concentration = 0.15 g/L
²⁾detergent concentration = 0.5 g/L, defoamer concentration = 0.015 g/L

Die inventive defoamers A-E clearly show the desired behavior that the foam is not influenced in the main washing cycle and reduced significantly in the rinsing cycle.

1. A foam forming aqueous composition, comprising:
i) at least 2.0 g/L of a detergent; and
ii) at least one defoamer being a compound of formula (I)
R¹OOC—Z—COOR² (I),
wherein R¹ and R² are independently from each other selected from C₁-C₂₀ branched alkyl, C₅-C₁₀ cycloalkyl or C₅-C₁₄ aryl or heteroaryl and can be different or identical,
and the linker Z is selected from divalent aliphatic or aromatic groups such as —(CH₂)ₙ— with n=1-20, 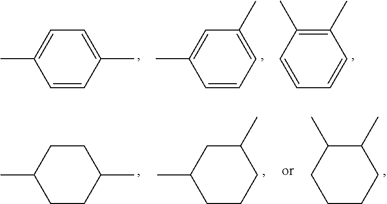
and wherein the ratio between the detergent and the defoamer is in the range of 19:1 to 35:1.

2. The foam forming aqueous composition according to claim 1, wherein the defoamer has a surface tension in the range of 23 to 35 mN/m.

3. A foam forming aqueous composition, comprising:
i) at least 2.0 g/L of a detergent; and
ii) at least one defoamer having a surface tension in the range of 23 to 35 mN/m.

4. The foam forming aqueous composition according to claim 3, wherein the defoamer is a compound of formula (I)
R¹OOC—Z—COOR² (I),
wherein R¹ and R² are independently from each other selected from C₁-C₂₀ branched alkyl, C₅-C₁₀ cycloalkyl or C₅-C₁₄ aryl or heteroaryl and can be different or identical,
and the linker Z is selected from divalent aliphatic or aromatic groups such as —(CH₂)ₙ— with n=1-20,

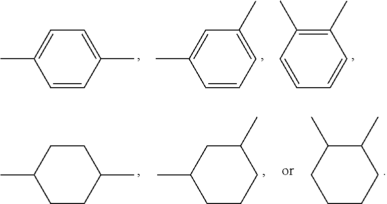

5. The foam forming aqueous composition according to claim 1, wherein the defoamer is selected from phthalic esters, adipic acid esters, cyclohexane dicarboxylic acid esters or mixtures thereof.

6. The foam forming aqueous composition according to claim 1, wherein the defoamer is selected from diisononyl phthalate, di-2-propyl-heptyl phthalate, cyclohexane dicarboxylic acid diisononylester, adipic acid di-2-ethylhexylester, adipic acid diisononylester or mixtures thereof.

7. The foam forming aqueous composition according to claim 1, wherein the detergent is selected from linear alkylbenzenesulfonates, alkylethersulfates, alkylsulfonates or mixtures thereof.

8. A foam, obtained from the foam forming composition according to claim 1.

9. A washing process, comprising the steps of:
a) providing a foam forming aqueous composition comprising at least 2.0 g/L of a detergent and a defoamer according to claim 1;
b) a main washing cycle wherein the composition provided in step a) is agitated so that foam formation occurs; and
c) a rinsing cycle wherein the composition obtained in step b) is diluted so that the detergent concentration is reduced to 0.7 g/L or less.

10. The washing process according to claim 9, wherein the volume of the foam obtained in step b) is
i) not reduced by more than 10%, compared to an aqueous composition of identical detergent concentration not comprising any defoamer, during the main washing cycle and
ii) reduced by at least 80%, compared to the initial foam volume obtained in step b), during the rinsing cycle.

11. A laundry detergent, comprising,
i) 95 to 99.5 wt.-% of a detergent; and
ii) 0.5 to 5.0 wt.-% of a defoamer being a compound of formula (I)
R¹OOC—Z—COOR² (I),
wherein R¹ and R² are independently from each other selected from C₁-C₂₀ branched alkyl, C₅-C₁₀ cycloalkyl or C₅-C₁₄ aryl or heteroaryl and can be different or identical,
and the linker Z is selected from divalent aliphatic or aromatic groups such as —(CH₂)ₙ— with n=1-20, 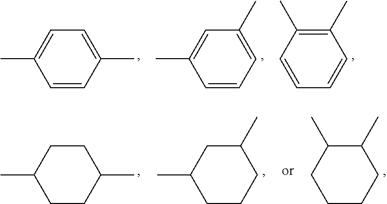
and/or having a surface tension in the range of 23 to 35 mN/m.

12. The laundry detergent according to claim 11, wherein the defoamer is selected from phthalic esters, adipic acid esters, cyclohexane dicarboxylic acid esters or mixtures thereof.

13. The laundry detergent according to claim 11, wherein the defoamer is selected from diisononyl phthalate, di-2-propyl-heptyl phthalate, cyclohexane dicarboxylic acid diisononylester, adipic acid di-2-ethylhexylester, adipic acid diisononylester or mixtures thereof.

14. The laundry detergent according to claim 11, wherein said laundry detergent is a laundry detergent for handwash.

15. The foam forming aqueous composition according to claim 4, wherein R¹ and R² are independently from each other selected from C₅-C₁₄ aryl or heteroaryl and can be different or identical.
